(19) United States
(12) Patent Application Publication
(10) Pub. No.: US 2005/0054955 A1
(43) Pub. Date: Mar. 10, 2005

(54) Device for non-invasive ultrasound treatment of an object

(76) Inventor: Lars Lidgren, Lund (SE)

Correspondence Address: LADAS & PARRY LLP, 224 SOUTH MICHIGAN AVENUE, SUITE 1200, CHICAGO, IL, 60604, US

(21) Appl. No.: 10/500,815

(22) PCT Filed: Jan. 15, 2003
(86) PCT No.: PCT/SE03/00045

(30) Foreign Application Priority Data
Jan. 15, 2002 (SE) 0200090-9

(51) Int. Cl. A61H 1/00

(52) U.S. Cl. 601/2

(57) ABSTRACT

The present invention relates to a device for non-invasive ultrasound treatment of an object (5) of a patient, wherein at least two therapeutic ultrasound transducers (2a, 2b) are arranged for treatment of the object (5) by generating at least one ultrasonic field (3), the temperature focus (F) of which can be located in the object (5). A diagnostic ultrasound transducer (8) is arranged to determine the acoustic properties of the patient's (4) tissue (10) between the area on which the therapeutic ultrasound transducers (2a, 2b) are to be located during treatment and the object (5) in order to, in dependence of the acoustic properties determined by the diagnostic ultrasound transducer (8), set the therapeutic ultrasound transducers (2a, 2b) relative to the object (5).

The present invention relates to a device for non-invasive ultrasound treatment of an object of a patient, wherein at least one therapeutic ultrasound transducer is arranged for treatment of the object by generating at least one ultrasonic field, the temperature focus of which can be located in the object.

The intervertebral disc consists of an outer fibrous tissue ring, annulus fibrosus, and an inner, more viscous part, nucleus pulposus. The disc functions as a shock absorber and if annulus fibrosus breaks, e.g. by a small fissuring, disc matter may find its way out and cause a compression of nerve roots and induce an inflammatory reaction.

Prolapsed intervertebral discs have been treated surgically since the thirties by removal of the displaced disc matter and/or a part of the bulging disc. Later, the surgical treatment has developed towards less invasive operations and now, percutaneous techniques are used for removing disc matter. An alternative method for surgical treatment is chemonucleolysis, where the enzyme chymopapain is injected into nucleus pulposus, the central part of the disc. The enzyme polymerizes the long proteoglycan chains in nucleus pulposus with subsequent loss of the hygroscopicity. This reduces the volume and pressure in nucleus pulposus and the bulging part of the disc, which explains the pain relief patients with sciatica experience after chemonucleolysis. The method has proven to give pain relief in 75 per cent of the cases and has a well documented cost efficiency. Unfortunately, the method has caused serious allergic reactions in about 1 per cent of the cases. Next step in the development could be a non-invasive treatment of prolapsed inter-vertebral discs, which preferably should be painless, avoid the risk for infections and carried through ambulatory.

A method for thermotherapy and coagulation of tissue involves use of focused ultrasound with high intensity. The ultrasound passes well through soft tissue and can be focused on remote spots within a surface of a few millimeters. The energy absorption in the tissue increases the temperature with a sharp temperature gradient such that the boundaries of the treated volume are clearly limited without causing any damages on the surrounding tissue (U.S. Pat. No. 5,291,890, U.S. Pat. No. 5,501,655). Ultrasound treatment of prolapsed intervertebral discs is previously known (EP 0 872 262).

Heat treatment of discs has proven successful in a method called IDET (U.S. Pat. No. 6,073,051, U.S. Pat. No. 6,007,570, U.S. Pat. No. 5,980,504). The method has as its aim to insert a catheter into the disc by means of a cannula. Farthest out on the catheter there is a coil which is heated by applying a radio frequency voltage thereon (U.S. Pat. No. 5,785,705). The heat is increased to about 90° C. in nucleus pulposus where the heating element of the catheter has been located and treatment is carried through for 15 minutes.

Surgery with focused ultrasound has several advantages compared with other thermal techniques. Firstly, it can be non-invasive, secondly, the focus can be made movable and thirdly, the energy can be supplied during short time intervals. The limitation of ultrasound is its absorption in bone and its poor penetration through gasfilled passages. Clinical applications of ultrasound surgery are today mostly used in ophthalmic surgery, urology and oncology. The effect of ultrasound can be divided into thermal and non-thermal effects.

The thermal effects of ultrasound are caused by absorption of ultrasound in the tissue. This leads to a temperature increase which is dependent on the parameters of the ultrasound (frequency and intensity) and the acoustic properties of the tissue. The absorption of ultrasound in musculoskeletal tissues increases with the apatite and protein content, which means high absorption in bone, cartilage, tendons and ligaments. Water however, has a low ultrasound absorption capacity and can for this reason be used as an acoustic medium between the ultrasound transducer and the tissue. Higher absorption can be expected in annulus fibrosus (high collagen content) than in nucleus pulposus (high water concentration). This will lead to higher temperatures in the outer part of the intervertebral disc than in the central part. In order to avoid that the temperature in annulus fibrosus exceeds a detrimental level at the same time as the temperature in nucleus pulposus reaches a sufficient level, the ultrasound can be transmitted from several ultrasound sources. In this manner, the fields will overlap each other and increase the effect in nucleus pulposus at the same time as the intensity in the surrounding tissue including annulus fibrosus can be kept low.

In devices for non-invasive ultrasound treatment of an object the ultrasonic field shall penetrate such parts of the patient's tissue between the area on which the therapeutic ultrasound transducer, which shall treat the object, is located and the object to be treated. Since the tissue structure in said parts of the patient's tissue and since the size of these tissue parts vary from patient to patient the power and/or the duration of the ultrasonic field have to be adapted thereto. Such an adaptation can be hard to accomplish.

An aim of the present invention has been to eliminate this problem and the problem has been solved by the before mentioned device comprising the characterizing features of the subsequent claim 1.

Due to the device comprising a diagnostic ultrasound transducer for determination of the acoustic properties of parts of the patient's tissue between the area in which the therapeutic ultrasound transducer is to be located for treatment and the object, one can easily adapt the ultrasonic field of the therapeutic ultrasound transducer to the tissue structure of said different patients and to the size of the tissue parts through which the ultrasonic field is to be directed.

The invention will be described in more detail with reference to the accompanying drawings, in which:

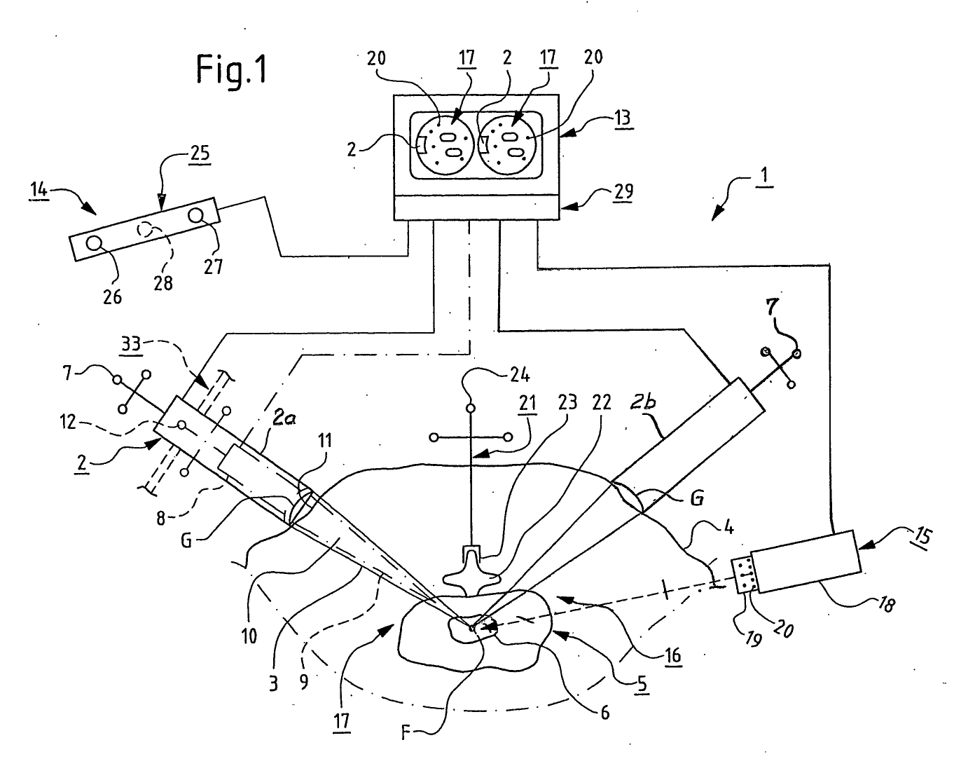

FIG. 1 schematically shows a constructive embodiment of the device according to the invention; and

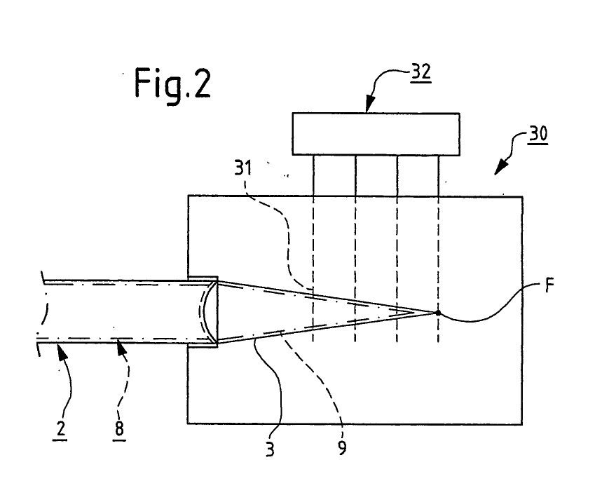

FIG. 2 schematically shows a calibration device which can be comprised in a device according to FIG. 1.

The treatment device 1 schematically illustrated in FIG. 1 is adapted to produce, by means of one or several therapeutic ultrasound emitting devices 2, one or several ultrasonic fields 3, the temperature focus F of which is intended to be located in the patient's 4 object 5 for treatment thereof. According to one embodiment of the invention, the device 1 is adapted for treatment of the patient's intervertebral disc 5, preferably nucleus pulposus 6, and in the following description reference will be made to treatment of a patient's disc. However, it should be understood that the invention is not limited to such treatment, but can be used in treatment of another object such as a ligament in a shoulder, knee, elbow or a foot, a blood vessel or a superficial object sensitive to ultrasound treatment.

The ultrasound emitting device 2 comprises at least one therapeutic ultrasound transducer 2a and/or 2b for generating said ultrasonic field 3.

The ultrasound emitting device 2 can comprise a plurality of, preferably three or more, position emitters 7 for determination of its position.

The therapeutic ultrasound transducer 2a and/or 2b is more exactly adapted to achieve a local temperature increase in nucleus pulposus 6 so that enzymes such as collagenase present in the disc 5 are activated and cause decomposition of collagen and proteoglycanes, which results in shrinking of nucleus pulposus 6 mainly because of less hygroscopicity. The therapeutic ultrasound transducer 2a and/or 2b can for example emit its ultrasonic field 3 dorsolaterally from several different ports simultaneously. In order to be able to vary the focal distance of the therapeutic ultrasound transducer 2a and/or 2b, i.e. the distance between its transmitter element G and the temperature focus F, said transmitter element G can be of the type phased array, which comprises several small piezoelectric elements. By excitation of these elements with different time delays a focussed ultrasonic field 3 is achieved.

However, the therapeutic ultrasound transducer can also be a single ultrasound transducer of a non-phased array type and having a focussing property. In the case of such an ultrasound transducer, the transmitter element can comprise a single piezoelectric element or be manufactured of several laminates or layers of piezoelectric elements. Further, the therapeutic ultrasound transducer of non-phased array type can be used in the treatment of blood vessels or other superficial objects of the patient.

The treatment device 1 can also comprise a diagnostic ultrasound transducer 8. This is intended to achieve an ultrasonic field 9 for determination of the acoustic properties of the patient's 4 tissue 10 between the area 11 of the patient 4 on which the therapeutic ultrasound transducer 2a and/or 2b is to be located during treatment and the disc 5, preferably nucleus pulposus 6, to be treated. This time of flight measurement with the diagnostic ultrasound transducer 8 is performed in order to determine the distance between said area 11 and nucleus pulposus 6 and the thickness of the tissue and of the different tissue layers.

The tissue 10 that is penetrated consists in said order of skin, fat, muscle and annulus fibrosus. This information is needed to correct for differences in different patients' size and tissue configuration since the attenuation is different in different kinds of tissue.

The diagnostic ultrasound transducer 8 can comprise a plurality of, preferably three or more, position emitters 12 for determination of its position and it is arranged to achieve an image of said tissue 10 in a monitor 13.

The treatment device 1 can also comprise an optical navigating device 14 for navigation of the therapeutic ultrasound transducer 2a and/or 2b (U.S. Pat. No. 5,772,594). This optical navigating device 14 can comprise at least one diagnostic camera 15 which is intended to produce at least one image of the anatomical structure 17 of the treatment area 16 in the monitor 13. The diagnostic camera can be an X-ray camera 18 taking two pictures of the anatomical structure 17 of the treatment area 16 from different directions with preferably a 90° intermediate angle and displaying these pictures in the monitor 13. At the optical navigating device 14, the X-ray camera 18 is used together with an optical analog-digital-converter for obtaining a real time image in the monitor 13 of the position and direction of the therapeutic ultrasound transducer 2a and/or 2b (U.S. Pat. No. 6,021,343, U.S. Pat. No. 5,834,759, U.S. Pat. No. 5,383,454).

The X-ray camera 18 can comprise a positioning device 19—e.g. a cylindrical cover—which is located in front of the lens of the X-ray camera 18 and having markers 20 the mutual distances of which are known. The markers 20 can be round and consist of metallic material e.g. tantalum.

In the optical navigating device 14, a reference device 21 can also be comprised, which reference device 21 is arranged to be attached to the spinous process 23 of a vertebra 22 or in a corresponding position such that it gets a determined position relative to the treatment area 16. The reference device 21 can comprise several position transmitters 24, namely preferably at least three, and these can consist of metallic material e.g. tantalum.

Furthermore, the optical navigating device 14 can comprise a signal receiving and/or signal sending unit 25. This unit can comprise a suitable number of signal receivers 26, 27 for receiving signals from the therapeutic ultrasound transducer's 2a and/or 2b position transmitter 7, the diagnostic ultrasound transducer's 8 position transmitter 12 and the reference device's 28 position transmitter 24. The signal receiving and/or signal sending unit 25 can possibly comprise one or several signal transmitters 28 for transmitting signals to said position transmitters 7, 12 and 24, which are arranged to receive these signals.

The signals transmitted by the position transmitters 7, 12 and 24 can e.g. be in the form of infrared light or visible light or radio frequency electromagnetic waves or acoustic waves and the signal receivers 26, 27 can in such case be receivers of infrared light or visible light or radio frequency electromagnetic waves or acoustic waves.

The treatment device 1 can also comprise a computer 29 with at least one software arranged to calculate an appropriate setting of the therapeutic ultrasound transducer's 2a and/or 2b transmitter element G, in dependence of the acoustic properties determined by the diagnostic ultrasound transducer 8, such that the temperature focus F of the therapeutic ultrasound transducer's 2a and/or 2b ultrasonic field 3 can be obtained in the disc 5, preferably nucleus pulposus 6, to be treated.

Said software can alternatively, or in combination with said setting of the therapeutic ultrasound transducer 2a and/or 2b be arranged to calculate the position of the temperature focus F of the therapeutic ultrasound transducer's 2a and/or 2b ultrasonic field 3 in relation to the therapeutic ultrasound transducer 2a and/or 2b, in dependence of said acoustic properties and the therapeutic ultrasound transducer's 2a and/or 2b setting with regard to its focussing properties, such that the therapeutic ultrasound transducer 2a and/or 2b by means of the above mentioned optical navigation device 14 can be positioned such that said temperature focus F is obtained in the disc 5, preferably nucleus pulposus 6, to be treated.

The computer 29 can comprise a software arranged to calculate the power of the therapeutic ultrasound transducer's 2a and/or 2b ultrasonic field 3 in its temperature focus F in dependence of the acoustic properties determined by the diagnostic ultrasound transducer 8, such that the temperature increase accomplished in nucleus pulposus 6 by the therapeutic ultrasound transducer 2a and/or 2b can be estimated.

In the treatment device 1 there can also be included a calibrating unit 30 for calibration of (a) the position of the therapeutic ultrasound transducer's 2a and/or 2b temperature focus F relative to its transmitter element G and (b) the therapeutic ultrasound transducer's 2a and/or 2b emitted heating power in said temperature focus F. The calibrating unit 30 has similar acoustic properties as human tissue and contains a plurality of thermoelements 31 by means of which the position and the power of said temperature focus F can be measured for calibration. The thermoelements 31 are connected to a schematically illustrated measuring device 32.

Prior to treatment of the disc 5, preferably nucleus pulposus 6, the reference device 21 can be located on the patient's 4 vertebra 22 and the therapeutic ultrasound transducer 2a and/or 2b and the diagnostic ultrasound transducer 8 can be calibrated in the calibrating unit 30. Thereafter a tissue analysis is performed by means of the diagnostic ultrasound transducer 8, which preferably is navigated by means of the optical navigation device 14 by its position transmitters 12 cooperating through signals with the signal transmitters 26, 27. On the monitor 13 a tissue image can be produced which image is given by the diagnostic ultrasound transducer 8 and the thereby measured values of the tissue are used to adjust the focal distance and the power of the therapeutic ultrasound transducer 2a and/or 2b.

Two X-ray images of the patient's 4 anatomical structure 17 at the disc 5 is taken and these X-ray images are displayed on the monitor 13. On these X-ray images, the position of the reference device's 21 position emitter 24 relative to the disc 5 can then be determined by means of the markers 20 of the positioning device 19.

During treatment of the disc 5, preferably nucleus pulposus 6, the therapeutic ultrasound transducer 2a and/or 2b is navigated by means of the signal receiving or signal sending unit 25, whereby the navigation is presented in the X-ray images on the monitor 13. This is accomplished in that the position transmitters 7 of the therapeutic ultrasound transducer 2a and/or 2b cooperate through signals with the signal transmitter 26 of the signal receiving or signal sending unit 25. By means of said navigation, the therapeutic ultrasound transducer 2a and/or 2b can be positioned such that the temperature focus F of its ultrasonic field 3 will fall in the disc 5, preferably nucleus pulposus 6. The temperature in the temperature focus F preferably exceeds 45° C.

The treatment can be automatically interrupted if the patient 4 moves to an incorrect position relative to the therapeutic ultrasound transducer 2a and/or 2b or vice versa.

The invention is not limited to the method described above, but can vary within the scope of the following claims.

Thus, the object 5 can be any disc in the body or another object of the patient. The diagnostic camera 15 can be a computerized tomography (CT) scanner which is arranged to produce images of said anatomical structure 17 and these images can be processed in a computer program or software for obtaining a 3D-image in the monitor 13. The diagnostic camera 15 can alternatively be an X-ray camera or a magnetic resonance imaging (MRI) camera, which is arranged to generate images of said anatomical structure 17 and these images can be processed in a computer program for obtaining a 3D-image in the monitor 13.

The therapeutic ultrasound transducer 2a and/or 2b can be arranged to be positioned manually or be arranged at a positioning device 33 for positioning the same relative to the disc 5 to be treated. The signal receiving and signal sending unit 25 of the optical navigation device 14 can be an X-ray device. The diagnostic ultrasound transducer 8 can comprise transmitter elements of phased array type to be able to vary the length or range of its ultrasound radiation.

If the ultrasound transmitter device 2 comprises at least two therapeutic ultrasound transducers 2a, 2b these can be locatable in different positions relative to each other and in such positions relative the disc 5, preferably nucleus pulposus 6, to be treated, that they together can generate the ultrasonic field 3 and its temperature focus F in said disc 5, preferably nucleus pulposus 6.

The therapeutic ultrasound transducers 2a, 2b can be controllable to together generate the ultrasonic field 3 with such an intensity that the tissue close to the disc 5, preferably nucleus pulposus 6, is not exposed to temperatures harmful for the tissue. They can also be controllable in order to be able to vary the distance between themselves and the temperature focus F of the ultrasonic field 3.

The therapeutic and diagnostic ultrasound transducers 2a, 2b and 8 can be one and the same, they can be co-located or they can be arranged at several locations.

The described apparatus can be used in methods for treatment of discs but also for treatment of other objects in the body. As an example of such other objects can be mentioned ligaments in for example shoulders, knees, elbows or feet, blood vessels, and other superficial objects.

Further, it should be understood that dependent on the object to be treated different steps and components described above can be excluded. The optical navigation device and/or the reference device can for example be excluded in the case of treatment of ligaments since these structures often are superficial and having a site easy to determine.

1. Device for non-invasive ultrasound treatment of an object, wherein at least two therapeutic ultrasound transducers are arranged for treatment of the object by generating at least one ultrasonic field, the temperature focus of which can be located in the object, and wherein a diagnostic ultrasound transducer is arranged to determine the acoustic properties of the patient's tissue between the area on which said therapeutic ultrasound transducers are to be located for treatment and the object to be treated to, in dependence of the acoustic properties determined by the diagnostic ultrasound transducer, adjust said therapeutic ultrasound transducers relative to the object to be treated, wherein said therapeutic ultrasound transducers are locatable in different positions relative to each other and in such position relative to the object to be treated that they together can generate the ultrasonic field and its temperature focus in said object, that said therapeutic ultrasound transducers are controllable for generating an ultrasonic field with such intensity that tissue close to the object is not exposed to tissue harmful temperatures, and that said therapeutic ultrasound transducers are controllable in order to be able to vary the distance between the same and the temperature focus of the ultrasonic field.

2. Device according to claim 1, wherein the diagnostic ultrasound transducer cooperates with a computer comprising at least one software arranged to calculate appropriate setting of said therapeutic ultrasound transducers in dependence of the acoustic properties determined by the diagnostic ultrasound transducer, such that said temperature focus can be brought to be achieved in the object to be treated, whereby said software can alternatively or in combination with above mentioned setting of said therapeutic ultrasound transducers be arranged to calculate the position of the temperature focus of said therapeutic ultrasound transducers in dependence of said acoustic properties and said therapeutic ultrasound transducers setting with regard to its focusing properties, such that said therapeutic ultrasound transducers can be positioned such that said temperature focus is achieved in the object to be treated.

3. Device according to claim 2, wherein said computer comprises at least one software arranged to calculate the heating effect of said therapeutic ultrasound transducer's ultrasonic field in its temperature focus in dependence of the acoustic properties determined by the diagnostic ultrasound transducer.

4. Device according to claim 1, wherein the diagnostic ultrasound transducer is arranged to determine the thickness of different tissue layer of said tissue in order to determine the acoustic properties thereof.

5. Device according to claim 1, wherein the diagnostic ultrasound transducer is arranged to produce an image of said tissue.

6. Device according to claim 1, wherein the diagnostic ultrasound transducer comprises transmitter elements of phased array type in order to vary the length of its ultrasound radiation.

7. Device according to claim 1, wherein said therapeutic ultrasound transducer cooperates with an optical navigating device comprising at least one diagnostic camera adapted to produce at least one image of the anatomic structure of the treatment area within which the object to be treated is located and in that the optical navigation device further comprises at least one signal receiving or signal sending unit adapted to receive signals from or send signals to position transmitters on
a) a reference device which has a fixed position relative to the object, and
b) said therapeutic ultrasound transducer such that the position thereof relative to said treatment area can be determined.

8. Device according to claim 1, wherein the diagnostic ultrasound transducer comprises position transmitters cooperating with the signal receiving or signal sending unit.

9. Device according to claim 7 or 8, wherein the signal receiving or signal sending unit is arranged to receive or send signals in the form of infrared light or visible light or radio frequency electromagnetic waves or acoustic waves and that said position transmitters are arranged to send or receive signals in the form of infrared light or visible light or radio frequency electromagnetic waves or acoustic waves.

10. Device according to claim 9, wherein the diagnostic camera is an X-ray camera.

11. Device according to claim 10, wherein the X-ray camera comprises a positioning device with markers which are intended to determine the position of the anatomical structure of the treatment area displayed in a monitor.

12. Device according to claim 11, wherein the monitor is arranged to display two X-ray photographs of said anatomical structure taken with the X-ray camera from two different locations.

13. Device according to claim 7, wherein the diagnostic camera is a computerized tomography (CT) scanner which is arranged to produce images of the anatomical structure at the patient's object, which images are processed in a computer program (software) for obtaining a 3D-image in a monitor.

14. Device according to claim 7, wherein the diagnostic camera is a X-ray camera or a MRI scanner which is arranged to produce images of the anatomical structure at the patient's object, which images are processed in a computer program (software) for obtaining a 3D-image in a monitor.

15. Device according to claim 1, wherein the ultrasound transmitting device comprises at least one therapeutic ultrasound transducer arranged to be positioned manually by means of calculated determination of the temperature focus of said therapeutic ultrasound transducer's ultrasonic field relative to said therapeutic ultrasound transducer's transmitter element.

16. Device according to claim 1, wherein, the ultrasound transmitting device comprises at least one therapeutic ultrasound transducer arranged at a positioning device for positioning of the same relative the object to be treated.

17. Device according to claim 1, wherein the ultrasound transmitting device comprises at least one therapeutic ultrasound transducer comprising a transmitter element of phased array type in order to move the ultrasonic field and its temperature focus.

18. Device according to claim 1, wherein the ultrasound transmitting device is arranged to generate a temperature focus, the temperature of which exceeds 45° C.

19. Device according to claim 1, wherein a positioning device is arranged for calibration of the power generated by said therapeutic ultrasound transducer in the temperature focus and/or the position of said temperature focus relative to said therapeutic ultrasound transducer.

20. Device according to claim 7, wherein the reference device is arranged to be attached to a vertebra in the patient's vertebral column, preferably to the spinal process of said vertebra.

21. Device according to claim 7 or 20, wherein the reference device comprises position transmitters consisting of metallic balls, preferably tantalum balls.

22. Device according to claim 21, wherein the signal receiving or signal, sending unit of the optical navigating device is at least one X-ray device.

23. Device according to claim 1, wherein said therapeutic and diagnostic ultrasound transducers are co-located.

24. Device according to claim 1, wherein said therapeutic and diagnostic ultrasound transducers are arranged at several locations.

25. Device according to claim 1, wherein the device is arranged for non-invasive ultrasound treatment of an object in the form of nucleus pulposus in the patient's disc.

26. Device according to claim 1, wherein the device is arranged for non-invasive ultrasound treatment of an object in the form of a ligament in a shoulder or a knee.

27. Use of a device according to claim 1, wherein the device is used in methods for treatment of an object in a patient's body, such as for treatment of nucleus pulposus in discs.

28. Use of a device according to claim 1 wherein the device is used in methods for treatment of an object in a patient's body, such as ligaments in for example shoulders or knees.

29. Use of a device according to claim 1, wherein the device is used in methods for treatment of an object in a patient's body, such as blood vessels.
